(19) United States
(12) Patent Application Publication
(10) Pub. No.: US 2013/0332858 A1
(43) Pub. Date: Dec. 12, 2013

(54) LOOP BASED SOCIAL NETWORKING

(71) Applicant: Jernat Abundance, LLC, Bedford, PA (US)

(72) Inventors: Jeremy Weber, Bedford, PA (US); Nathan Weber, Bedford, PA (US)

(21) Appl. No.: 13/914,040

(22) Filed: Jun. 10, 2013

Related U.S. Application Data
(60) Provisional application No. 61/658,193, filed on Jun. 11, 2012.

(51) Int. Cl. H04L 29/06

(52) U.S. Cl. CPC H04L 65/403
USPC 715/753

(57) ABSTRACT

One aspect provides a loop based social networking site. An embodiment provides for loops, a loop comprising a list or group of registered users bound together as an electronic group, and provides a mechanism of pushing communications to members of a loop. As such, on joining as a member of a particular loop, the loop member will have events of the loop automatically pushed to the user's personal or individual loop site, including in some cases automatic addition of the event to the personal calendar of the loop member. In this way, a loop can ensure that each member has received particular communications. Each loop member consents to accepting loop information/communications by virtue of joining the loop. Other aspects are described and claimed.

This application claims priority to prior U.S. Patent Application Ser. No. 61/658,193, which is incorporated by reference herein.

### BACKGROUND

Social networking sites and services such as FACEBOOK, ORKUT, TWITTER, LINKEDIN and GOOGLE+ social networking sites have established various mechanisms to foster communication among users. For example, users may communicate with one another using existing social networking sites via email, text, status updates, short message postings, group event invitations, instant messenger programs and the like. With the possible exception of group event invitations, these communications tend to focus on past events. For example, users often tweet about what they have just witnessed or experienced, make a status update about where they currently are (checking in), post photos of a recent event, and the like. FACEBOOK is a registered trademark of Facebook Inc. in the United States and other countries. ORKUT and GOOGLE+ are registered trademarks of Google Inc. in the United States and other countries. TWITTER is a registered trademark of Twitter Inc. in the United States and other countries. LINKEDIN is a registered trademark of Linkedin Corp. in the United States and other countries.

### BRIEF SUMMARY

In summary, one embodiment provides a method, comprising: providing, using a processor and a memory device, a visual display on a display screen including a group calendar; providing, using the processor, a display interface for entry of an update to the group calendar; updating, using the processor, the group calendar based on the entry of the update; determining, using the processor and a stored list of contacts, one or more group members subscribed to the calendar, the group members corresponding to additional user accounts subscribed to the group calendar; and providing, using the processor, a calendar update to one or more subscribing member calendars of one or more group members; the calendar update provided to the one or more subscribing members matching an entry on the group calendar based on the entry of the update.

In an embodiment, the calendar update provided to the one or more subscribing members may be automatically pushed to the one or more subscribing members.

In an embodiment, the display interface for entry of an update to the group calendar may be restricted to a group leader.

In an embodiment, an update entered into to a calendar of the one or more subscribing member calendars by the one or more subscribing members may not be communicated to the group calendar.

In an embodiment, the method may comprise providing, using a processor, an additional communication to the one or more subscribing members corresponding to the calendar update provided to the one or more subscribing members. The additional communication may be provided via an alternate communication channel as compared to the calendar update provided to the one or more subscribing members. The alternate communication channel may comprise an SMS messaging communication channel.

In an embodiment, the additional communication may comprise a link embedded within the calendar update provided to the one or more subscribing members. The link may comprise a link to a web site of a group associated with an activity referenced within or associated with the calendar update provided to the one or more subscribing members.

In an embodiment, the method may comprise providing a home screen on the display screen; wherein the display interface for entry of an update to the group calendar is accessible from the home screen. The home screen may comprise a summary of updates from a plurality of calendars. The plurality of calendars may be calendars of groups to which a user of the display interface for entry of an update to the group calendar is subscribed. In an embodiment, the summary of updates from a plurality of calendars may not update the group calendar.

In an embodiment, the home screen may provide an additional communication interface for contacting the one or more subscribing members. The additional communication interface for contacting the one or more subscribing members may include one or more of an email interface, an SMS messaging interface, and an instant messaging interface.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example loop interface.

FIG. 2 illustrates an example computing device.

FIG. 3 illustrates another example computing device.

FIG. 4 illustrates an example method of communicating a group calendar update to one or more subscribing member calendars.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of claimed embodiments. One skilled in the relevant art will recognize, however, that the various described embodiments can be practiced without one or more of the specific details, or with other methods, components, materials, et cetera. In other instances, well-known structures, materials, or operations are not shown or described in detail. The following description is intended only by way of example, and simply illustrates certain example embodiments.

Existing social networking sites tend to focus on past events. For example, users often post pictures, small text-based notes (for example status updates or tweets), or other communications to social networking sites that are focused on past events. Also, existing social networking sites are not easily integrated with event planning arrangements. For example, existing calendaring systems are not integrated into or provided by existing social networking sites. Moreover, existing stand alone calendar applications are individual user focused, and tend to operate according to an opt-in mechanism on a per event basis. Thus, existing social networking sites do not provide calendaring services and simply provide a mechanism to invite individuals or groups of individuals to future events. Very similar to a social networking site electronic invite, conventional electronic stand alone calendars place the focus on an invite—accept mechanism of operation. Among other difficulties, such arrangements are cumbersome and time consuming, and do not lend themselves to easy organization of future events. Moreover the decision to include events on a user's calendar is not made at the group level but rather at the individual level, which may be unacceptable in certain circumstances.

Accordingly, an embodiment provides a loop based social networking site. An embodiment provides for loops, a loop comprising a list or group of registered users bound together as an electronic group, and provides a mechanism of pushing communications to members of a loop. As such, on joining as a member of a particular loop, the loop member will have events of the loop automatically pushed to the user's personal or individual loop site, including in some cases automatic addition of the event to the personal calendar of the loop member. In this way, a loop can ensure that each member has received particular communications. Each loop member consents to accepting loop information/communications by virtue of joining the loop.

In one embodiment, a pushed communication of a loop includes a calendar event. In the example of a loop pushing a calendar event, the calendar event information is formulated by a loop leader or administrator (or a user with like level access to the loop), and one entry is pushed to the members of the loop collectively. On receipt of the loop calendar event, the loop calendar event is added to the loop member(s) individual or personal calendars automatically. The calendar event may include a reminder that is automatically populated to loop users' reminder lists.

The addressing of loop events may be maintained at the loop level. For example, if a loop administrator adds a loop event, the loop event is communicated to each loop member and added to the calendar of each loop member automatically (without need for a loop member to “accept” a calendar event as with an invitation). This may be accomplished by the loop leader or event author pushing a communication out to other loop members or via a poling mechanism whereby the other loop members periodically pull information in. Also, the addressing may be more refined than loop level addressing. For example, in a work loop, a loop event only affecting a sub set of the work loop may be communicated to only those loop members (sub set) that it will effect. The event will again automatically be added to the sub-set of loop member calendars because of their loop membership.

Different loops may have different characteristics, including different communication characteristics. In an example, an embodiment for a local loop may allow a personal loop user to push calendar events to other loop members. In contrast, in another example, a national or regional loop may restrict the ability to push calendar entries to the loop members, for example reserving this functionality to a loop leader or administrative team.

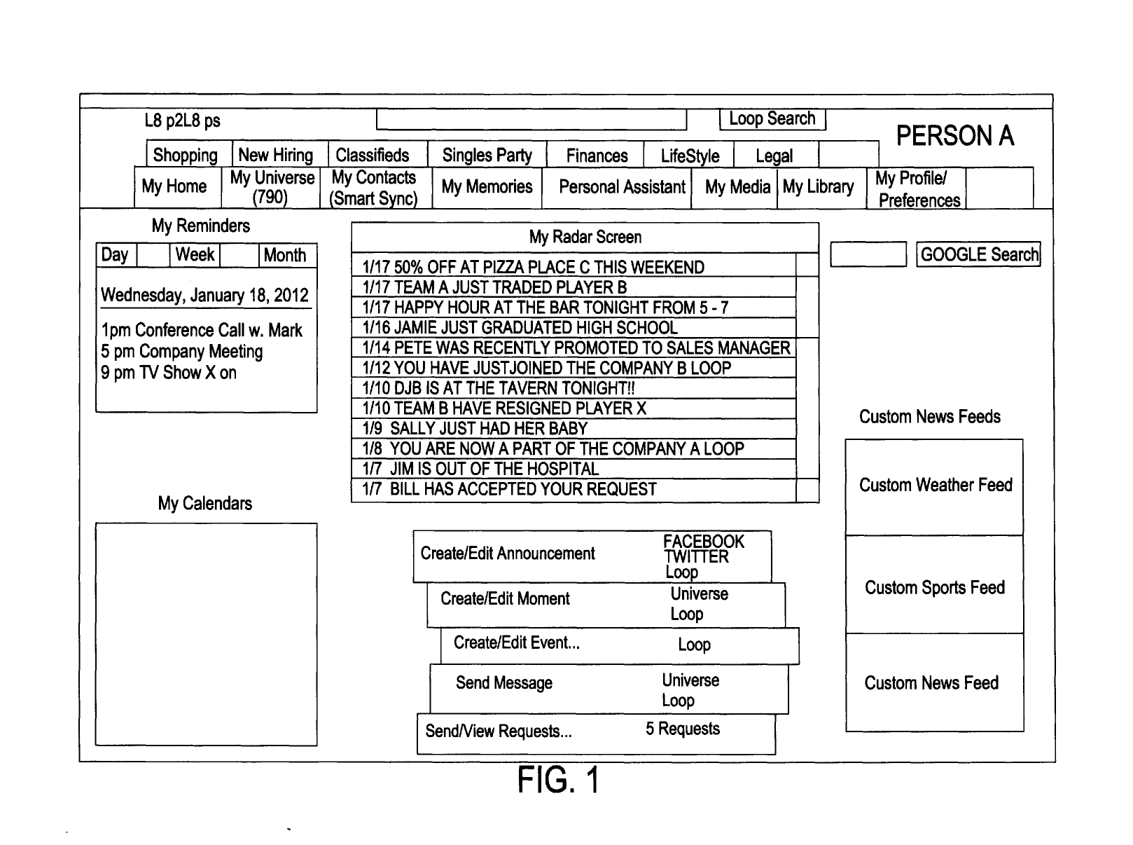

Turning to FIG. 1 an example user interface is illustrated. The example user interface may be included in a display of an electronic device, such a tablet or laptop computer, and hosted within a web browser application. Thus, a user may access a web server hosting web pages corresponding to the user's loop social networking site, in a similar fashion to how a user may access other social media sites using a web browser running in an electronic device having an Internet connection. Alternatively, the interface illustrated in FIG. 1 may be provided as a downloadable application that is at least partially stored on an electronic device such as a user's smart phone or tablet computing device, and populated with information retrieved from various network locations over a network connection such as a WLAN or WAN network connection.

Regardless of the host application format, the user interface generally includes a plurality of tabs or like organizational navigation menu items for selecting various pages or sub-sets thereof. Illustrated in the example of FIG. 1 is a “My Home” tab in the foreground of the user interface. The illustrated example “My Home” tab includes, among others, sub-sections of “My Reminders”, “My Calendar”, “My Radar Screen”, and “Custom News Feeds”, each of which at least in part acts to display information for the user.

For example, the “My Reminders” section lists the user's current reminders, such as derived from the loop calendar. The “My Calendar” is the loop populated calendar view where the individual user can see his or her personal calendar, which will include at least event entries from the loop(s) the user is subscribed to. The “My Radar Screen” is a quick look at interesting events or communications that the user may want to access quickly; this information may be selected and organized based on a user's preferences. Similarly, “Custom News Feeds” may be selected and modified based on user preferences to present relevant information on the “My Home” tab of the user's loop social networking web page.

The “My Home” tab may also contain a search box for executing an Internet search, and modules for content creation. For example, modules for content creation may include a “Create/Edit Announcement” module, a “Create/Edit Moment” module, a “Create/Edit Event” module, a “Send Message Module” and a “Send/View Requests” module. Each module contains executable code that, when provided to a processor of a computing device, performs some functionality.

For example, the “Create/Edit Announcement” and “Send Message” modules allow the user to communicate or post information to other social network site users with varying degrees of refinement. The “Create/Edit Event” module allows the user to create a calendar event and add it to his or her calendar. In the case that the user may push calendar entries (or other communications) to other users, the “Create/Edit Event” module similarly allows the user to populate other loop calendars and sites with entries or information, respectively. The “Send Message Module” allows the user to send messages to other loop social networking site users, for example via embedded email or instant messenger programs. The “Send/View Requests” module permits the user to send and review various requests related to the loop social network site, including for example reviewing or sending requests regarding joining different loops.

An embodiment has at its core a calendar functionality that filters loop calendar information, automatically posts loop events to loop member calendars, and automatically sets reminders. Additionally, embodiments may supplement or alternatively use other loop communications information for automatic population to loop member's social networking sites. For example, a job search or recruiting loop may comprise members that have job seeker resumes automatically pushed to loop members. Likewise, job searchers may have job positing information automatically pushed to their loop social networking sites. In one embodiment, a job search loop may comprise members including both job seekers and employers, where the communication functionality in the loop is defined by sub-loops within the loop. For example, the job seekers may be permitted to push resumes to members of the employer sub loop; likewise, employers may be permitted to push information such as job postings to job seeker sub-loop members.

Embodiments support a variety of communication types based on such loop filtering. As another example, an embodiment provides dating site functionality; prospective dates may have their profile information pushed to one another in the loop. Other loop categories may include but are not limited to shopping loops, legal loops, family loops, friend loops, financial loops, club loops, and the like.

One example embodiment supports six general types of loops including personal loops, business internal loops, business external loops, club local loops, club non-local loops and family loops. When a loop leader adds a loop event to a calendar, the event is pushed to all looped calendars for automatic synchronization. Reminders may be attached to all events. The events provide an opportunity for advertising. For example, an event that is added to a calendar may include an advertisement, either embedded or a link to an advertisement on the Internet. Thus, for an event for a local club baseball league that is sponsored by a local business, the calendar entry could include a link to the local business or other advertising materials. The advertising materials may likewise be included in the event reminder. Reminders and updates are available in email or text format. The advertising materials may likewise be included in association with other in-loop communications.

Personal loops may be used by individuals or small groups, such as a family. Personal loops may be private, that is, only viewable by members accepted or added to the loop. Personal loops may pull (or have pushed to, or both) information such as calendar events and entries from any other type of loop. That is, personal loops may have information pushed to the personal calendar on request/subscription. Personal loops may only push to certain other loops, such as other personal loops, family or small group loops, or club local loops.

Certain loops may be combined to form a “universe” of social networking interconnection. For example, personal/family, business internal and club local loops may be bound together to form a universe of loops for a user. Inter-loop messaging is available within a universe of related loops. For example, for a club local loop that is job searcher related, a job searcher may join the loop and provide a resume that is pushed to all employers on the loop with in a geographic area. Thus, the loop subscription is defined by geographic area and by activity status, that is “now hiring” in this non-limiting example. Similarly, for a local dating or singles loop, dating profiles of loop members may be pushed to other members of the loop.

Some loops may be made publicly available. For example, business loops may be made publicly available. Businesses may thus use the business external loop for marketing purposes. For example, a business external loop may have multiple personal/family loop subscribers. The business may populate or push marketing related information to the loop members. For example, the business may push sales information to a calendar of loop members automatically and set a reminder of the sale. Events may push to all connected loops, allowing businesses great opportunities for extensive advertising. However, for certain loops, such as a business external loop, other loops cannot access control or push information or events to other loop members that are subscribed to such a controlled loop. However, users of subordinate loops, such as a personal loop subscribed to the business loop, may communicate with the administrator of the business loop to inquire about accessing push functionality. However, while business external loops are generally not within the personal loop universe, the business external (or any loop) may be converted to another type of loop, as desired.

An embodiment provides a business internal loop that facilitates communication within a business. Events such as calendar entries for workers schedules may be added to the loop members calendars via a loop leader, such as a management level employee, adding to the business internal loop calendar page. Such added events will be automatically pushed to personal loop member pages, and thus automatically populate the personal calendars of the loop members. This ensures that the individual loop members receive appropriate calendaring information. For example a manager may add a calendar entry for Employee A to work on Monday night at 4:00 p.m.-8:00 p.m. Once added to the manager's calendar on the manager's page, the entry information is automatically pushed to the other members of the loop. Thus, the manager can be assured that Employee A is aware that he or she is scheduled to work on Monday night at 4:00 p.m.-8:00 p.m. As described herein, optionally the other loop members or a particular sub set of loop members may receive another communication in addition to the loop calendar entry information regarding Employee A, such as a communication letting another employee (Employee B) know that he or she does not have to work because Employee A has been scheduled. In one embodiment, such communications may be pushed (automatically or via manual selection) to users' personal devices, such as preregistered phones associated with the users, via another communication channel (for example, text message). Optionally, personal loop members may be able to push information or otherwise populate information to the business internal loop calendar of a management level employee—thus communicating it to the other individual loop members.

Optionally, a business internal loop calendar is private. That is, the business internal loop calendar is only visible to other loop members and not to the public generally. A business internal loop may include sub-loops (for example, accounting, sales, marketing, customer service and the like) that may be accessed via toggling between tabs. Alternatively, a business may choose to set up multiple business internal loop sites. Business internal loops of sub-loops thereof may be added to part of the personal loop universe.

An embodiment provides a club local loop site. A club local loop site is characterized by including a public calendar. The events that are added to the club local loop site's calendar may be automatically pushed to loop member's personal calendars with reminders. Club non-local loop sites, in contrast, may push events to a club local loop site's calendar with reminders, but the events and reminders of the club local loop will not be pushed to the club non-local loop site's calendar. Similarly, the club local loop may be configured in some embodiments to accept events and reminders (or other like communications) from personal loop sites. The club local loop is in the personal loop universe.

An embodiment provides for club non-local loop sites. The club non local loop site's calendar is characterized in having a public calendar. The events of the club non-local loop calendar push automatically to the club local loop sites' calendars with reminders. The club non-local loop site may not be part of the personal loop universe. The club non-local loop web site and components thereof (for example, the calendar) may be configured to accept events from certain other loop members, for example certain club local loop member sites. Thus for example a club non-local loop site of a national level club may or may not allow events to be pushed from or otherwise derived from a club local or regional loop. In contrast, the club local loops of the local or regional clubs would be configured to accept the national level club's events to populate the club local loop calendars.

A family loop is provided by an embodiment. In such an embodiment, the calendar may be private. The personal loop website, a loop member of the family loop, automatically pushes or pulls events from the family loop calendar. For example, if a family includes users “A”, “B”, “C” and “D”, and user “A” adds an event to his or her calendar, it may be automatically pushed to the family loop and thus populate the personal calendars of users B, C, and D. However, a user retains control over which events to publish. That is, user A may add an event to his or her calendar but not push it to the other loop members.

Generally, an embodiment provides configurations for facilitating calendar entry sharing. Thus, an embodiment coordinates individual calendars via a rule set that establishes relationship parameters between individual instantiations of calendars. Thus, a loop of calendars is a group of calendars associated by the rule set. In some loops, there may be a hierarchical configuration of calendar instantiation. For example, a club non-local calendar may be an actual loop site having a public calendar that defines and organizes the loop, visible to other members and the public. In other instantiations, the loop may simply be a collection of individual calendars that have a hierarchical relationship but lack a public or visible leader loop site. For example, a family loop may be set up as a group of individual calendars, with a parental calendar established as able to push and pull information, while child calendars are only able to receive information. The parental calendar may or may not be visible to the other members of the loop. In still other instantiations, the individual loop sites may all be on equal footing; thus, the rule set gives each individual calendar site the ability to populate other calendar sites with information. In the event of conflicts, simultaneous entries may be added but with a warning message to one or more loop members potentially affected by the conflict.

In certain embodiments, loops therefore connect to form universes of interaction. Certain embodiments facilitate short text based messaging, for example 140 character announcements that are authored at a loop site and communicated to the members of the universe. The universe or parts thereof (loops or sub-loops) may likewise be connected to other, conventional social media sites. A loop user may import contacts form other sources, such as an existing social media site, in order to formulate a loop universe, facilitate sending of invitations to join a loop, and the like. Thus, certain embodiments are focused on connecting users based on future events via convenient organization and distribution of scheduling information.

Loop users may of course communicate in a more conventional fashion about past events or memories, including communications having photos and comments. However, certain embodiment also add announcement capabilities for users that want or need such announcements. Announcements communicate meaningful information that is broadcast to the loop. Using embodiments, there is no need to wonder what other loop members have planned for the evening or the weekend, as this information should be communicable to the entire loop, at least in certain embodiments.

In some embodiments, events appear in calendars and individuals can message or make announcements about the events.

In some embodiments, moments are major events, and can become temporary loops in and of themselves. For example, a moment may auto connect other site users into a temporary or new loop, or a sub-loop of an existing loop, and thus transform into a memory. Such temporary or new loops or sub-loops may automatically be suggested to a user for formation or may automatically form without the need for user input. Thus, those attached in some way to the memory are added to the memory loop—which may operate in similar fashion to the other loops as described herein.

Loops may be implemented in a variety of contexts. For example, loops may be implemented in an educational or work context, with mandatory or non-optional membership for students and employees, for example. Thus, a teacher may implement a class loop, where the teacher can populate the loop members' calendars with homework assignments, picture day, parent teacher conferences, field trips, et cetera. Similarly, a yearbook committee loop would update teacher and student members' calendars about deadlines and meetings. Sports team loops may update practice schedules, fundraiser deadlines, pep rallies, and the like. Parent teacher organization loops may be used to communicate meeting times and fundraiser deadlines to students, parents, and the like. Likewise, an employer may create a work loop and populate the loop member calendars with work schedules. Other possible loops include but are not limited to union loops, custodian loops, school district loops, chorus group loops, NHS loops, et cetera.

In business internal loops a manager may push sales goals information, deadline information, meeting information, et cetera directly to team calendars. A business external loop may be used to broadcast to customer loop members, push event notifications and scheduling information to customers, find new employees, et cetera. Thus, in a loop universe, visible or public calendars may take on a billboard like effect provide advertising opportunities. Large and small businesses alike may replace or augment their current online presence with loop(s).

Loop communications, including calendar events, notifications, announcements, memories and the like, may be analyzed at varying levels to automatically select advertisements to be included. For example, in pushing a calendar entry to loop members, business external calendar entry information may be automatically associated via analysis of key words therein and matching the key words to advertisements or advertising categories for advertisement selection. On selection, an advertisement (or link thereto) may be included in or associated with the loop communication, as described herein.

In an embodiment, a user may create and manage as many loops as needed under the same user account. Thus, one embodiment may not use any sub-loops. Thus, an embodiment permits one user name and password for multiple “accounts”. In an embodiment, a user may establish practically an unlimited number of loops per account or virtually unlimited accounts. A user may thus manage a personal loop, two family loops, a local club and four business loops with one account and log in, for example. This is tremendously user friendly/convenient.

One embodiment provides a loop system that is similar to how people connect in real life. People tend to connect with one another based on their common interests. For example, if a user enjoys a certain restaurant, clothing store, club, school, or person, the user may utilize an embodiment to connect to that loop of interest and its calendar. This creates a natural filter that exists in real life—i.e., connections based on shared interest.

By way of example, if users A, B, C and D are using an embodiment and other social sites (e.g., FACEBOOK social networking site, GOOGLE+ social networking site, etc.), in all other social networking sites users are either totally, 100% “friends” (i.e., connected to a news feed, etc.) or not. Thus, users A, B, C and D will be forced to see all updates of their friends or connections, irrespective of whether these users actually want that degree of connectivity.

In contrast, an embodiment allows users A, B, C and D to all be subscribers to a loop and be in each other's universe, but not see any of each other's announcements. For example, user A may subscribe to several loops that user B is in and all the loops that user C is in. Just like in real life, the more people have in common or have similar interests, the more they will interact using embodiments described herein because they will cross paths more often. According to an embodiment, the system of loops allows for that same environment. Even though a user's universe is comprised of all the people in the user's personal, family, business internal and club local loops, the user's radar screen will have “announcements” post in proportion to the user's interests and connections with those in his or her universe.

Therefore, an embodiment allows a user, e.g., via selectively joining particular loop (e.g., club local loop) to receive certain updates, e.g., calendar updates for club local activities, but nonetheless avoid unnecessary updates (e.g., unrelated postings or announcements of other members of the club, etc.). Thus, an embodiment allows a user to get the necessary/desirable information in areas of commonality with other users, but omits the rest.

As a specific example, consider a user that is a member of class of '95. The user doesn't stay in contact with 95% of the class. The class of '95 may all be subscribers of the class of '95 loop and get class information therefrom. Because the class of '95 is a local loop, each user would be in each others' universe to allow for direct messaging or email type of communication, but a user would not see any of the other class of '95 subscribers announcements or posts unless the class of '95 loop pushed such an announcement as its own. The users would have to have another type of connection, e.g., personal loop to personal loop, or each belong to another loop having access to make an announcement for that loop, in order for announcements to be seen.

Accordingly, embodiments provide a system that recreates the barriers and eliminates the “noise” that is on other social networking sites. The loop system thus provides a filtering of the people that can make announcements into another user's radar screen. The loop system narrows the content to that which a user is actually interested in. For example, a user may receive a community's club announcements from the president with posting authority, but another user that is a member of the club won't post information to the club about non-club issues. So a user is able to receive announcements entered by users only with respect to the Club.

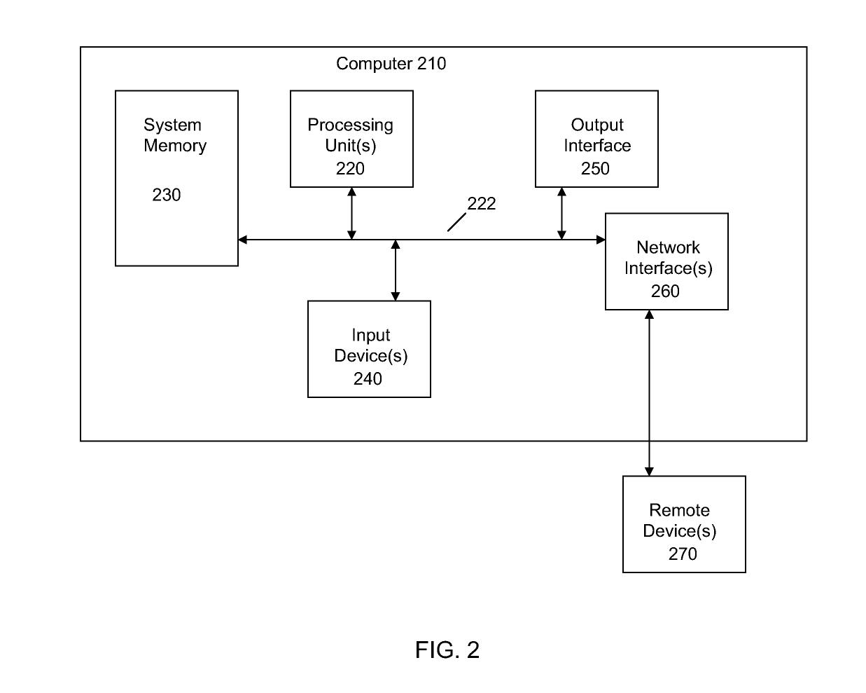

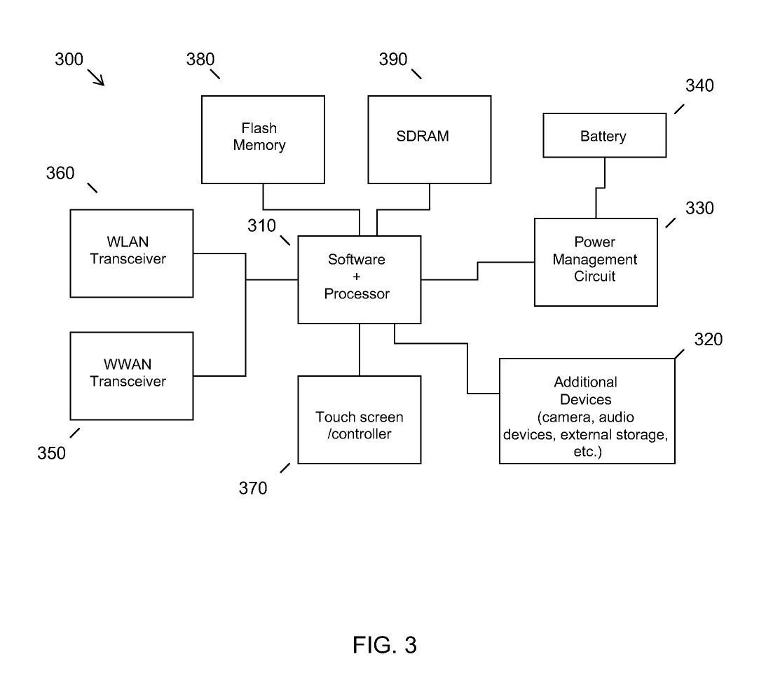

It will be understood by those having ordinary skill in the art that embodiments may be implemented in one or more information handling devices configured appropriately to execute program instructions consistent with the functionality of the embodiments as described herein. In this regard, FIG. 2 and FIG. 3 illustrate non-limiting examples of such devices and components thereof. While servers and mobile computing systems such as tablet computers, laptop computers, and smart phones have been specifically mentioned as examples herein, embodiments may be implemented using other systems or devices, such as desktops, workstations, and the like.

Referring to FIG. 2, it will be readily understood that embodiments may be implemented using any of a wide variety of devices or combinations of devices, for example for implementing functionality as described herein. An example device that may be used in implementing embodiments includes a computing device in the form of a computer 210. In this regard, the computer 210 may execute program instructions configured to provide loop communication management and data display, and perform other functionality of the embodiments, as described herein.

Components of computer 210 may include, but are not limited to, at least one processing unit 220, a system memory 230, and a system bus 222 that couples various system components including the system memory 230 to the processing unit(s) 220. The computer 210 may include or have access to a variety of computer readable media. The system memory 230 may include computer readable storage media in the form of volatile and/or nonvolatile memory such as read only memory (ROM) and/or random access memory (RAM). By way of example, and not limitation, system memory 230 may also include an operating system, application programs, other program modules, and program data.

A user may interface with (for example, enter commands and information) the computer 210 through input devices 240. A monitor or other type of device can also be connected to the system bus 222 via an interface, such as an output interface 250. In addition to a monitor, computers may also include other peripheral output devices. The computer 210 may operate in a networked or distributed environment using logical connections (network interface 260) to other remote computers or databases (remote device(s) 270), such as for communication between devices comprising system 200. The logical connections may include a network, such local area network (LAN) or a wide area network (WAN), but may also include other networks/buses.

Other devices may be used in implementing various aspects as described herein. For example, referring to FIG. 3, with regard to smart phone and/or tablet circuitry 300, an example includes an ARM based system (system on a chip) design, with software and processor(s) combined in a single chip 310. Internal busses and the like depend on different vendors, but essentially all the peripheral devices (320) may attach to a single chip 310. In contrast to the circuitry illustrated in FIG. 2, the tablet circuitry 300 combines the processor, memory control, and I/O controller hub all into a single chip 310. Also, ARM based systems 300 do not typically use SATA or PCI or LPC. Common interfaces for example include SDIO and I2C. There are power management chip(s) 330, which manage power as supplied for example via a rechargeable battery 340, which may be recharged by a connection to a power source (not shown), and in at least one design, a single chip, such as 310, is used to supply BIOS like functionality and DRAM memory.

ARM based systems 300 typically include one or more of a WWAN transceiver 350 and a WLAN transceiver 360 for connecting to various networks, such as telecommunications networks and wireless base stations. Commonly, an ARM based system 300 will include a touch screen 370 for data input and display. ARM based systems 300 also typically include various memory devices, for example flash memory 380 and 3DRAM 290.

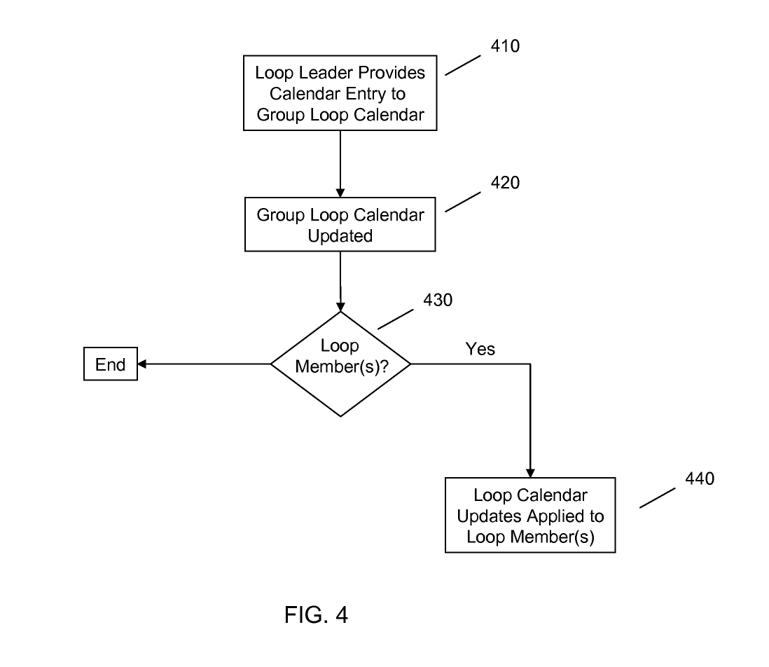

Referring to FIG. 4, an embodiment therefore permits a loop leader, e.g., a manager at work or a parent, to provide a calendar entry to the group's loop calendar at 410. This calendar entry then updates the group loop calendar at 420. The updated group loop calendar then triggers a determination by an embodiment if there are any members of the loop at 430. If not, the group loop calendar update need not be communicated to any other members. In contrast, if there are loop members, e.g., workers or children members of a work loop or a family loop, then an embodiment identifies the loop members and supplies information for updating the loop member calendars automatically at 440. If there are loop members, e.g., as for example contained in a group's contact list, the members may be automatically identified and provided calendar update information.

The updating of the member calendars may be accomplished by pushing an update communication over a network connection to the group member devices, pushing information to a central device to update the member accounts, including their calendars, or may be accomplished via providing the information in response to a poll from other devices (e.g., member devices seeking updates). Accordingly, an embodiment provides a mechanism, which may be one way (e.g., only the group leader is authorized to make group calendar updates), that allows a group calendar's updates to be automatically incorporated into subscribing members' calendars.

As will also be appreciated by one skilled in the art, aspects may be embodied as a system, method or computer program product. Accordingly, aspects of the present invention may take the form of an entirely hardware embodiment, or an embodiment including software (including firmware, resident software, micro-code, et cetera) that may all generally be referred to herein as a “circuit,” “module” or “system.” Furthermore, aspects of the present invention may take the form of a computer program product embodied in at least one computer readable medium(s) having computer readable program code embodied therewith.

Any combination of at least one computer readable medium(s) may be utilized. A computer readable storage medium may be, for example, but not limited to, an electronic, magnetic, optical, electromagnetic, infrared, or semiconductor system, apparatus, or device, or any suitable combination of the foregoing. More specific examples include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible or non-signal medium that can contain or store a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments may be written in any combination of programming languages, including an object oriented programming language such as Java, Smalltalk, C++ or the like and conventional procedural programming languages, such as the “C” programming language or similar programming languages. The program code may execute entirely on a first computer, partly on the first computer, as a stand-alone software package, partly on the first computer and partly on a remote computer or entirely on the remote computer or server. In the latter scenario, the remote computer may be connected to the first computer through any type of network, including a local area network (LAN) or a wide area network (WAN), or the connection may be made to an external computer (for example, through the Internet using an Internet Service Provider). Some aspects may be downloaded over the Internet for local execution or streamed to a remote device for local execution, while maintained and or otherwise managed in a cloud based computing system.

Embodiments are described with reference to figures of methods, apparatus (systems) and computer program products according to embodiments. It will be understood that portions of the figures can be implemented by computer program instructions. These computer program instructions may be provided to a processor to produce a machine, such that the instructions, which execute via the processor, create means for implementing the functions/acts specified.

These computer program instructions may also be stored in a computer readable medium that can direct a device to function in a particular manner, such that the instructions stored in the readable medium produce an article of manufacture including instructions which implement the function/act specified. The program instructions may also be loaded onto a device to cause a series of operational steps to be performed on the device to produce a computer implemented process such that the instructions which execute on the device provide processes for implementing the functions/acts specified.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Although illustrated example embodiments have been described herein with reference to the accompanying drawings, it is to be understood that embodiments are not limited to those precise example embodiments, and that various other changes and modifications may be affected therein by one skilled in the art without departing from the scope or spirit of the disclosure.

What is claimed is:

1. A method, comprising:
providing, using a processor and a memory device, a visual display on a display screen including a group calendar;
providing, using the processor, a display interface for entry of an update to the group calendar;
updating, using the processor, the group calendar based on the entry of the update;
determining, using the processor and a stored list of contacts, one or more group members subscribed to the calendar, the group members corresponding to additional user accounts subscribed to the group calendar; and
providing, using the processor, a calendar update to one or more subscribing member calendars of one or more group members;
the calendar update provided to the one or more subscribing members matching an entry on the group calendar based on the entry of the update.

2. The method of claim 1, wherein the calendar update provided to the one or more subscribing members is automatically pushed to the one or more subscribing members.

3. The method of claim 1, wherein the display interface for entry of an update to the group calendar is restricted to a group leader.

4. The method of claim 3, wherein an update entered into to a calendar of the one or more subscribing member calendars by the one or more subscribing members is not communicated to the group calendar.

5. The method of claim 1, further comprising providing, using the processor, an additional communication to the one or more subscribing members corresponding to the calendar update provided to the one or more subscribing members.

6. The method of claim 5, wherein the additional communication is provided via an alternate communication channel as compared to the calendar update provided to the one or more subscribing members.

7. The method of claim 6, wherein the alternate communication channel comprises an SMS messaging communication channel.

8. The method of claim 5, wherein the additional communication comprises a link embedded within the calendar update provided to the one or more subscribing members.

9. The method of claim 6, wherein the link comprises a link to a web site of a group associated with an activity referenced within the calendar update provided to the one or more subscribing members.

10. The method of claim 1, further comprising providing a home screen on the display screen;
wherein the display interface for entry of an update to the group calendar is accessible from the home screen.

11. The method of claim 10, wherein the home screen further comprises a summary of updates from a plurality of calendars.

12. The method of claim 11, wherein the plurality of calendars are calendars of groups to which a user of the display interface for entry of an update to the group calendar is subscribed.

13. The method of claim 12, wherein the summary of updates from a plurality of calendars do not update the group calendar.

14. The method of claim 10, wherein the home screen provides an additional communication interface for contacting the one or more subscribing members.

15. The method of claim 14, wherein the additional communication interface for contacting the one or more subscribing members includes one or more of an email interface, an SMS messaging interface, and an instant messaging interface.
